(19) United States
(12) Patent Application Publication
(10) Pub. No.: US 2002/0041678 A1
(43) Pub. Date: Apr. 11, 2002

(54) Method and apparatus for integrated echo cancellation and noise reduction for fixed subscriber terminals

(76) Inventors: Filiz Basburg-Ertem, Bethesda, MD (US); Kumar Swaminathan, North Potomac, MD (US)

Correspondence Address: Hughes Electronics Corporation, Patent Docket Administration, Bldg. 1, Mail Stop A109, P.O. Box 956, El Segundo, CA, 90245-0956, US

(21) Appl. No.: 09/870,757

(22) Filed: May 31, 2001

Related U.S. Application Data
(60) Provisional application No. 60/226,395, filed on Aug. 18, 2000.

(51) Int. Cl. H04M 9/08

(52) U.S. Cl. 379/406.01

(57) ABSTRACT

A method and apparatus for echo cancellation and noise reduction are provided that use synergy among system components. Double-talk detection is performed using either the voice activity detector of a codec or a secondary double-talk detector, depending on the signal-to-noise ratio (SNR) obtained from the encoder. The echo canceller is implemented via an adaptive filter and operates in a dual-mode. Under low SNR conditions, variable step-size methods, VAD-based double-talk detection and emergency coefficients are used. Under high SNR conditions, a secondary double-talk detector employing an echo loss return estimator and comparator for near-end and far-end levels is used, as well as a non-linear gain function and masking noise.

This application claims the benefit of U.S. Provisional Application No. 60/226,395, filed Aug. 18, 2000.

### CROSS REFERENCE TO RELATED APPLICATION

Related subject matter is disclosed in U.S. patent application Ser. No. 09/361,015, filed Jul. 13, 1999, the entire contents of said application being expressly incorporated herein by reference.

### FIELD OF THE INVENTION

The invention relates to echo cancellation and noise reduction in speech communication systems.

### BACKGROUND OF THE INVENTION

Echo is considered to be one of the most objectionable artifacts occurring in communication systems. It can be a result of a mismatch at the hybrid, as in the network echo case, or the reflections caused by a reverberant environment, as in acoustic echo. It can manifest itself as the originator of a speech signal being able to hear his/her own speech after a certain delay. With either kinds of echo, the annoyance factor increases as the amount of the delay increases.

Background noise, as well as being subjectively objectionable, can also disrupt the proper operation of the various subsystems of a communications system, such as the codec. Different kinds of background noise can vary widely in their characteristics, and a practical noise reduction scheme has to be capable of handling noises with different characteristics.

### SUMMARY OF THE INVENTION

In accordance with the present invention, an integrated echo and noise reduction system is presented for fixed subscriber terminals, for example. In accordance with an aspect of the present invention, an echo canceller preferably employs a normalized least mean square (NLMS) adaptation algorithm, and operates in a dual mode to handle both high signal-to-noise ratio (SNR) and low SNR conditions optimally. A variable step-size technique for adaptation, a novel double-talk detection method that makes use of the voice activity detector (VAD) of the codec, and a method which employs ‘emergency coefficients’ for more robust operation, are utilized when dealing with low SNR conditions. Under high SNR conditions, a secondary double-talk detector, far-end monitoring, a non-linear gain function and masking noise are used.

In accordance with another aspect of the present invention, a noise reduction unit is implemented by way of a single-microphone method and uses a spectral amplitude enhancement gain function with minimal spectral distortion. The noise reduction unit is utilized in a pre-compression configuration with the speech encoder, and it operates after the echo canceller on the send path, thereby reducing the residual echo, as well as noise.

The integrated system of the present invention has the advantage of utilizing the synergy among its components, that is, the codec, the noise reduction unit, and the echo canceller. The synergy among components manifests itself by a reduction of the overall computational complexity of the system by the use of a number of shared elements among the system components, as well as an improved performance from these elements working together. For example, the VAD of the codec plays a significant role in the operation of both the noise reduction unit and the echo canceller. The VAD provides the noise reduction unit with information on where the noise-only segments are, therefore making possible the determination of an accurate noise estimate. The VAD also provides a reliable double-talk detection scheme for the echo canceller. The noise reduction unit improves the performance of the echo canceller, as well as improving the subjective quality of speech. Also, as a result of being used as a post-processor to the echo canceller, the noise reduction unit decreases the dependence on a non-linear processor (NLP). The global SNR estimation from the codec used in the echo cancellation is another example of the synergy among the various components of the integrated system that is accomplished by the present invention.

### BRIEF DESCRIPTION OF DRAWINGS

The various aspects, advantages and novel features of the present invention will be more readily comprehended from the following detailed description when read in conjunction with the appended drawings, in which:

FIG. 1 is a block diagram of a speech communication system employing echo cancellation and noise reduction in accordance with an embodiment of the present invention;

FIG. 2 is a block diagram of an enhanced encoder having integrated noise reduction and voice activity functions configured in accordance with an embodiment of the present invention;

FIG. 3 is a flow chart depicting a sequence of operations for noise reduction in accordance with an embodiment of the present invention;

FIG. 4 depicts a window for use in a noise reduction algorithm in accordance with an embodiment of the present invention;

FIGS. 5A and 5B are graphs illustrating the effect of noise reduction on echo cancellation as implemented in accordance with an embodiment of the present invention; and

FIG. 6 is a block diagram of an echo canceller constructed in accordance with an embodiment of the present invention.

Throughout the drawing figures, like reference numerals will be understood to refer to like parts and components.

### DETAILED DESCRIPTION OF THE PREFERRED EMBODIMENTS

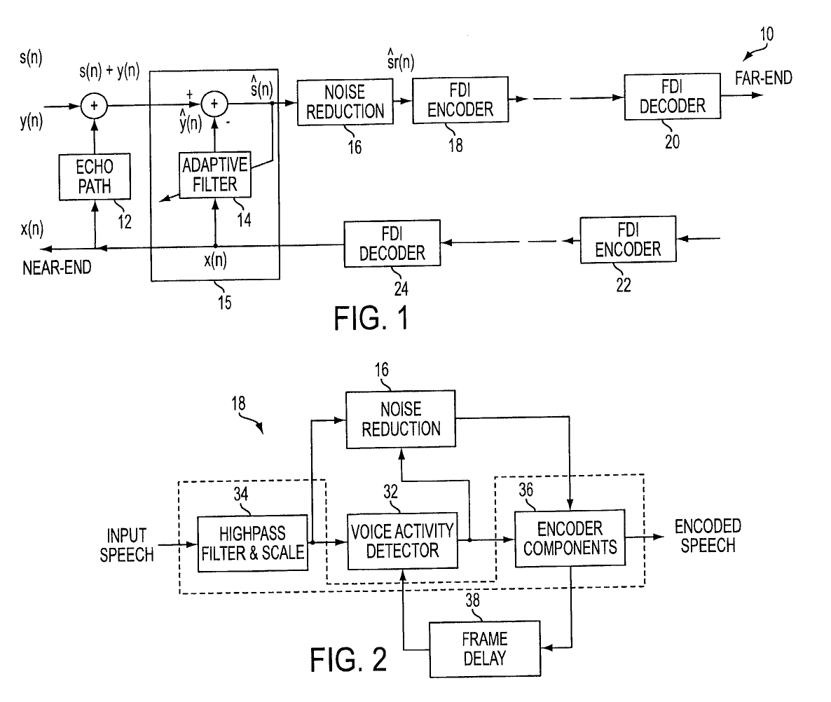

In accordance with the present invention, an integrated echo cancellation and noise reduction system is provided that can be used in fixed subscriber terminals. In order to address the two issues described above (i.e., the subjective objectionability of noise and echo to users in a communication system and the deleterious effects of noise and echo on system components), a combined echo cancellation and noise reduction system is presented and is implemented, by way of an example, into a 4.0 Kbps Frequency Domain Interpolative (FDI) codec. FIG. 1 depicts communication system 10 in accordance with an embodiment of the present invention.

The communication system 10 having integrated echo cancellation and noise reduction has the advantage of utilizing the synergy among a number of system components: the encoder 18, the noise reduction unit 16, and the echo canceller 15. FIG. 1 illustrates a communication path between near-end and far-end devices in the communication system 10 such as subscriber terminals. An undesirable echo path can occur at both ends. For discussion purposes, the treatment of the near-end echo path 12 will be described. It is to be understood that the integrated echo canceller 15 and the noise reduction unit 16 and the encoder 18 can be, but need not be, employed at the far-end, as indicated at 22. Similarly, the near-end and the far-end devices each employ a corresponding decoder 20 and 24.

A description of the noise reduction unit 16 follows: The echo canceller of the present invention shall then be described. The echo cancellation algorithm and the control mechanisms of the present invention can also be used for the elimination of network echoes after any necessary modifications are made to reflect the requirements of the network environment. It is to be understood that the synergy among the echo canceller 14, the noise reduction unit 16, and the encoder 18 described herein can be obtained, even if different codecs, echo cancellers, and noise reduction methods are used, as long as they support the set of computations described below.

1. Noise Reduction

The noise reduction unit is utlized in the pre-compression configuration. In this configuration, the noise reduction is performed prior to encoding, which allows the encoder to work with a clean input signal for better quality. Also, the fact that noise reduction is performed before, rather than after, encoding ensures that the input to the noise reduction has not been subjected to the possible degradations by the elements of the encoder. This presents less distortion at the output of the noise reduction unit.

As illustrated in FIG. 2, the noise reduction unit 16 uses the output of the voice activity detector (VAD) 32, which is an element primarily intended for the implementation of the discontinuous transmission (DT) mode of the codec. The function of the VAD is to determine at every frame whether there is speech present in the current frame. The high pass filter and scale module 34 shown in FIG. 2 is contained in the encoder, but is depicted as a separate unit to illustrate the location of the VAD 32 and the noise reduction unit 16 with respect to the rest of the system.

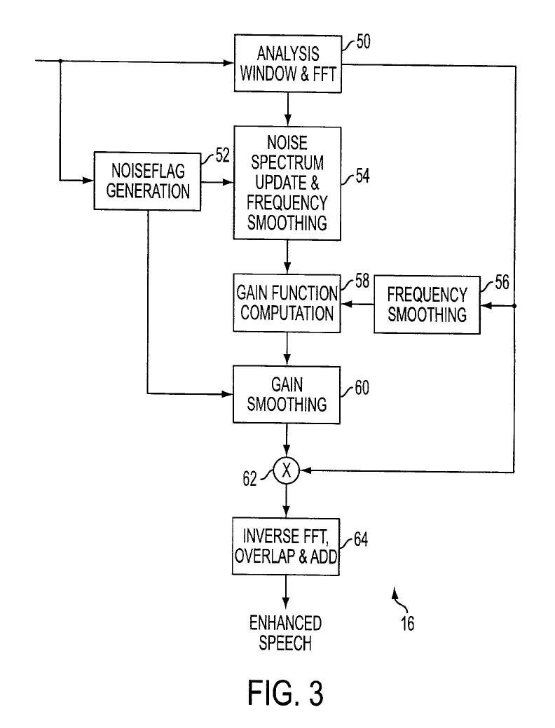

The noise reduction unit 16 implements an algorithm that belongs to a class of ‘single microphone’ solutions wherein there is access to the noisy signal through a single channel. The overall operation of the noise reduction unit 16, which uses a spectral amplitude enhancement technique, is illustrated in FIG. 3. The noise reduction unit 16 employs a nonlinear gain factor with minimum spectral distortion. Critical band-based smoothing is performed on the signal spectra that are input into the gain computations. Noise reduction is preferably performed using the magnitude spectra of the input signal. No processing is done on the phase, and the phase information from the original noisy signal is used to reconstruct the time domain signal at the last stage. The noise reduction unit 16 is described in the above-referenced U.S. patent application Ser. No.______, filed ______.

The spectral amplitude enhancement technique that is used in accordance with the present invention performs spectral filtering by using a non-linear gain function that depends on the input spectrum and the noise spectral estimate. Specifically,

¦\hat{S}(w)¦=¦H(W)¦¦Y(W)¦ (1)

where

Y(w)=S(w)+N(w) (2)

and Y(w) is the noisy input speech spectrum; S(w), the clean speech spectrum; N(w), the noise spectrum; ¦Ŝ(W)¦, the magnitude spectral estimate of the clean speech; ¦H(w)¦, the magnitude spectrum of the enhancement gain function, and ¦Y(W)¦, magnitude spectrum of the noisy input speech.

The success of the algorithm depends, to a great extent, on how well the noise estimator works. For example, in the event that a segment of the incoming signal, which contains speech, is incorrectly classified as noise only, this segment will be used to obtain a noise estimate which will have characteristics that are generally very different from that of the actual noise. In this case, the resulting noise reduced signal will have severe distortions. Therefore, knowing accurately which portions of the incoming signal contain speech, and which portions contain only noise, is critical. In this scheme, this distinction is made by using a robust VAD 32 with reduced sensitivity to varying signal levels. When the VAD 32 classifies an input frame as containing noise only (VAD=0), the noise estimate is updated. When the incoming frame contains speech (VAD=1), no noise estimate updating is performed, and the noise reduction unit uses the last updated value. The VAD decision also influences how the frequency smoothing of the noise estimate and the temporal smoothing of the gain function are carried out.

The gain function used in the spectral amplitude enhancement method is expressed as:

$$\vert H ( w ) \vert = \frac{{( \frac{\vert Y ( w ) \vert}{α} )}^{v}}{[ 1 + {( \frac{\vert Y ( w ) \vert}{α} )}^{v} ]} \qquad ( 3 )$$

where α is a variable threshold dependent on the noise spectral estimate, and Y(w) is the input noisy speech magnitude spectrum. Temporal variations of the gain function are confined to a certain range determined by the voice activity decision. By using this method, spectral magnitudes smaller than α are suppressed while larger spectral magnitudes do not undergo any change. The transition area can be controlled by the choice of ν. A large value causes a sharp transition, whereas a small value would ensure a large transition area. The threshold α is made frequency dependent by use of the spectral variance concept.

In accordance with another aspect of the present invention, both the noisy input speech spectrum and the noise spectral estimate that are used to compute the gain are smoothed in the frequency domain prior to the gain computation. Smoothing is necessary to minimize the distortions caused by inaccurate gain values due to excessive variations in signal spectra. The method used for frequency smoothing is based on the critical band concept. Critical bands refer to the presumed filtering action of the auditory system, and provide a way of dividing the auditory spectrum into regions similar to the way a human ear would, for example. Critical bands are often utilized to make use of masking, which refers to the phenomenon that a stronger auditory component may prevent a weak one from being heard. One way to represent critical bands is by using a bank of non-uniform bandpass filters whose bandwidths and center frequencies roughly correspond to a 1/6 octave filter bank. The center frequencies and bandwidths of the first 17 critical bands that span our frequency area of interest are as follows:

TABLE 1
Critical Band Frequencies

| Center | |
|---|---|
| Frequency | Band-width |
| (Hz) | (Hz) |
| 50 | 80 |
| 150 | 100 |
| 250 | 100 |
| 350 | 100 |
| 450 | 100 |
| 570 | 120 |
| 700 | 140 |
| 840 | 150 |
| 1000 | 160 |
| 1170 | 190 |
| 1370 | 210 |
| 1600 | 240 |
| 1850 | 280 |
| 2150 | 320 |
| 2500 | 380 |
| 2900 | 450 |
| 3400 | 550 |

In accordance with the smoothing scheme used by the noise reduction unit 16, the RMS value of the magnitude spectrum of the signal in each critical band is first calculated. This value is the assigned to the center frequency of each critical band. The values between the critical band center frequency are linearly interpolated. In this way, the spectral values are smoothed in a manner that takes advantage of auditory characteristics.

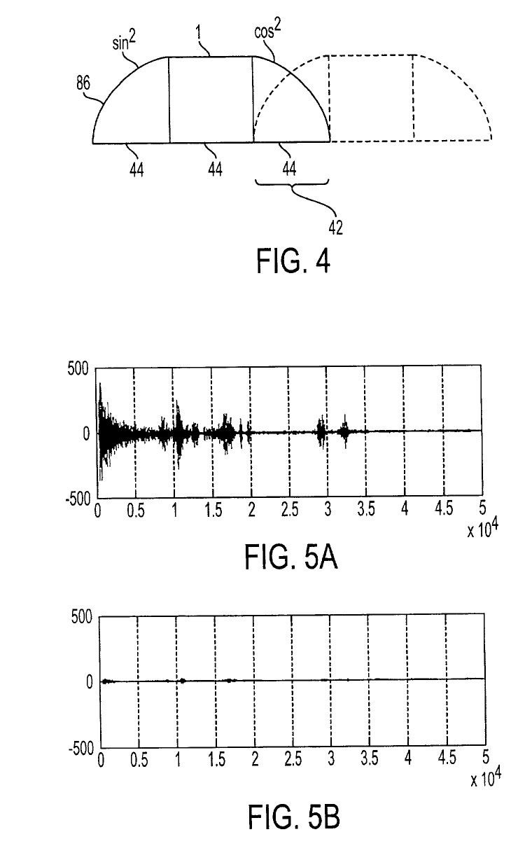

The noise reduction algorithm used with the noise reduction unit 16 of the present invention will now be described with reference to FIG. 3. As indicated in block 50, each frame of a sample input speech signal goes through a windowing and fast Fourier transform (FFT) process. The window 86 has a selected number of samples (e.g., 120 samples) and a selected overlap indicated generally at 42 in FIG. 4. The window 86 is preferably a modified trapezoidal window comprising three sections each labeled 44 (e.g., sin², unity and cos²) that are essentially the same length (e.g., 40 samples each). The sections can also be configured such that sin² and cos² sections are the same, but the middle section is a different length, that is, a different number of samples. The FFT size is preferably 256 points. A noise flag is provided, as shown in block 52. For example, the VAD 32 can be used to generate a noise flag, that is, the inverse of the voice activity flag that is generated by the VAD 32 when speech is detected. As shown in block 54, the noise spectrum is estimated. For example, when a frame is identified as having noise (e.g., by the VAD 32), the level and distribution of noise over a frequency spectrum is determined. The noise spectrum is updated in response to the noise flags. The estimate of the noise spectral magnitude is then smoothed by critical bands (e.g., see Table 1) and updated during the signal frames that contain noise.

With continued reference to FIG. 3, gain functions are computed (block 58) as described above using the smoothed noise spectral estimate and the input signal spectrum, which is also smoothed (block 56). As indicated in block 60, gain smoothing is performed to prevent artifacts in the speech output. This step essentially eliminates the spurious gain components that ate likely to cause distortions in the output. Gain smoothing is performed in the time domain by using concepts similar to those used in compandots. For example,

$$g ( i ) = \{ \begin{matrix}a \cdot g ( i - 1 ) , & if a \cdot g ( i - 1 ) < g ( i ) \\ b \cdot g ( i - 1 ) , & if b \cdot g ( i - 1 ) > g ( i ) \\ g ( i ) , & otherwise\end{matrix} \qquad ( 4 )$$

where g(i) is the computed gain, i is the time index, a>1,b<1 and a and b are attack and release constants, respectively. After the smoothed gain values are multiplied by the input signal spectra (block 62), the time domain signal is obtained by applying inverse FFT on the frequency domain sequence, followed by an overlap and add procedure (block 64). The values of a and b are chosen based on the signal-to-noise ratio (SNR) estimate obtained from the VAD 32 and on the voice activity indicator signal (e.g., VAD flag). During frames or segments classified as noise and for moderate-to-high SNRs, a and b are chosen to be very close to 1. This results in a highly constrained gain evolution across frames which, In turn, results in smoother residual background noise. During frames or segments classified as noise and for low SNRs, the value of a is preferably increased to 1.6, and the value of b is preferably decreased to 0.4, since the VAD 32 is less reliable. This avoids spectral distortion during misclassified frames and maintains reasonable smoothness of residual background noise.

During segments classified as containing voice activity and for moderate-to-low SNRs, the value of α is preferably ramped up to 1.6, and b is preferably ramped down to 0.4. This results in moderate constraints on the evolution of the gain across segments and results in reduced discontinuities or artifacts in the noise-reduced speech signal. During segments classified as voice active and for high SNRs (e.g., greater than 30 dB) the value of α is preferably ramped up to 2.2, and the value of b is ramped up to 0.8. This results in a lesser attack limitation and a greater release limitation on the gain signal. Such a scheme results in lower alternation of voice onsets and trailing segments of voice activity, thus preserving intelligibility.

The values provided for α and b in the preferred embodiment were derived empirically summarized in Table 2 below. It is to be understood that for different codecs and different acoustic microphone front-ends, an alternative set of values for α and b may be optimal.

TABLE 2
Attack and Release Constants

| VAD flag | SNR Estimate | a | b |
|---|---|---|---|
| 0 | moderate to high | 1.1 | 0.9 |
| | (>10 dB) | | |
| 0 | low | ramped up from 1.1 to | ramped down from 0.9 to |
| | | 1.6 | 0.4 |
| 1 | moderate to low | 1.6 | 0.4 |
| | (<30 dB) | | |
| 1 | high | ramped up from 1.6 to | ramped up from 0.4 to 0.8 |
| | | 2.2 | |

2. Echo Cancellation

Echo cancellation in accordance with the present invention is preferably performed by using an adaptive filter 14. The adaptive filter 14 creates a replica ŷ(n) of the echo signal y(n). When this replica is subtracted from the overall near-end signal, the echo is eliminated. The output of the echo canceller, or the ‘error signal’, ŝ is used to adjust the coefficients of the adaptive filter 14 by using an adaptation algorithm (e.g., a normalized least mean square (NLMS) adaptation algorithm) so that the coefficients converge to a close representation of the echo path.

When dealing with combined noise reduction and echo cancellation, an important issue to consider is the relative placement of these two components 15 and 16. It is well known that the performance of the NLMS-based method degrades significantly in the presence of high levels of background noise. Therefore, one implementation can be to place the noise reduction unit 16 prior to echo canceller 15 so that the noise-free input signal will facilitate better echo cancellation performance. This configuration, however, is disadvantageous because placing the noise reduction unit 16 prior to echo canceller 15 introduces nonlinearity in the echo path and causes poor echo cancellation performance. Thus, a more preferred method is to perform echo cancellation first, followed by noise reduction. This not only prevents the performance of the echo canceller 15 from degrading due to nonlinearities caused by the noise cancellation algorithm, but has the added benefit that the noise reduction unit 16 also reduces the residual echo from the echo canceller 15. This is especially important since, in a practical system, reduced residual echo minimizes the need for a non-linear processor (NLP), and therefore less distortion will be caused by its use. FIGS. 5A and 5B depict the effect of noise reduction on echo cancellation by comparing ŝ(n) and \hat{sr}(n) from FIG. 1. FIG. 5A shows residual echo and no noise reduction, whereas FIG. 5B shows residual echo after noise reduction.

The effect of the noise reduction unit 16 on the overall performance of the echo canceller 15 is only part of the synergy among the elements of encoder 18, the echo canceller 15 and the noise reduction unit 16. The echo canceller 15 also makes use of the VAD output of the encoder 18 to use as a reliable double-talk detector, as will be described below. The double-talk detector is important to the robust operation of the echo canceller 14. By using an already existing codec output for the determination of double-talk, it becomes possible to obtain this functionality without any additional computational load. In addition, the double-talk decision achieved by using the VAD output is usually more reliable than that achieved with conventional methods of double-talk detection, especially in high background noise conditions. This is therefore another example of the synergy among the codec, the echo canceller, and the noise reduction achieved by the present invention, as well as both reduced overall computational complexity and improved overall performance.

Another example of the synergy facilitated by the present invention is the use of the signal to noise ratio (SNR) estimate from the encoder 18. The SNR estimate is originally used for noise reduction by adjusting the amount of reduction at different noise levels. Its use with the echo canceller 15 makes it possible for the echo canceller 15 to operate in a dual mode for a more robust operation. For example, under low SNR conditions, variable step-size methods, VAD-based double-talk detection, and emergency coefficients are used. Also, in low SNR conditions, the noise reduction unit 16 acts as a mild NLP, as discussed above; therefore, the non-linear gain function and the masking noise need not be effective. When the SNR is high, however, a secondary double-talk detector, far-end monitoring, a non-linear gain function and masking noise are effectively used. Both the non-linear gain function and the masking noise are made to be level-independent. The reason behind the dual mode operation is to be able to manage high SNR and low SNR conditions as optimally as possible, thus giving way to a more robust overall performance. The afore-mentioned aspects of the echo canceller will be described in more detail below.

The echo canceller 15 has been designed to accommodate a tail-length of 16 milliseconds (ms), which corresponds to a tap-length of 128 at a 8000 Hz sampling rate. The echo at the subscriber end is assumed to consist of no more than two distinct reflections that result in an overall echo return loss (ERL) of at least 6 dB.

The adaptation algorithm employed by the echo canceller 15 of the present invention is preferably the NLMS algorithm for its relative simplicity and overall good performance. With NLMS, the coefficients of the adaptive filter 14 are updated according to:

$$W ( n + 1 ) = W ( n ) + μ \hat{s} ( n ) \frac{X ( n )}{{‖ X ( n ) ‖}^{2}} , \qquad ( 5 )$$

where, W(n)=[w₀(n)w₁(n) . . . w_{N-1}(n)]^{T} is the adaptive filter coefficient vector;, μ, the step

size, X(n)=[x(n) x(n−1) . . . x(n−N+1)]^{T} the input signal vector, and N, the length of the adaptive filter.

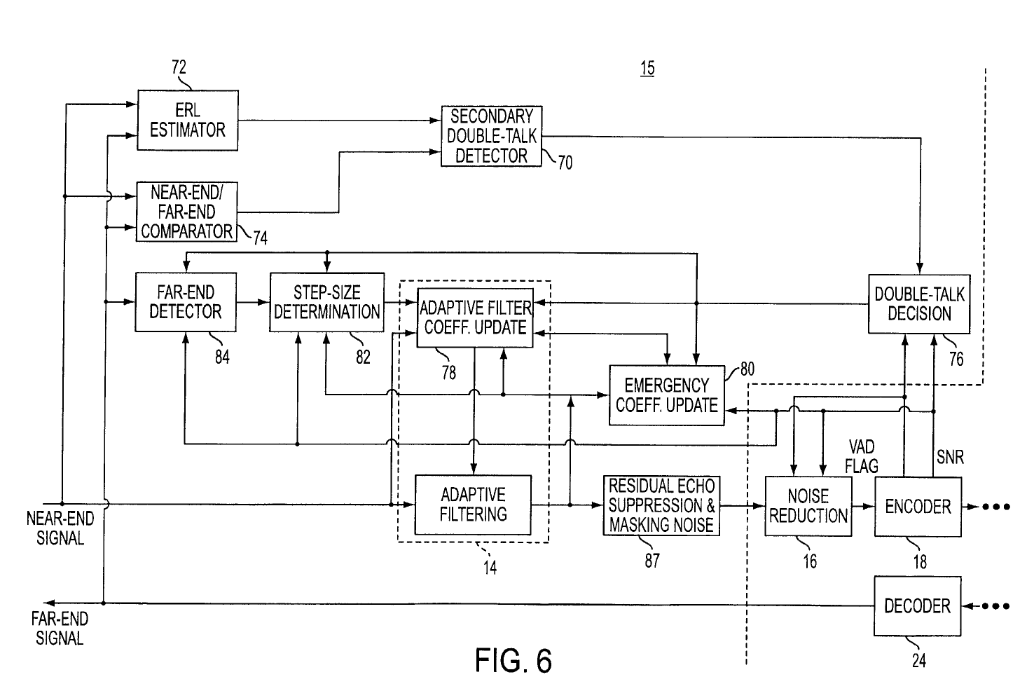

The success of any echo cancellation algorithm is very much dependent upon the various control mechanisms that determine how and when the adaptation algorithm is to be used. The following text in conjunction with FIG. 6 describes the primary control mechanisms incorporated in the system 10 in accordance with the present invention comprising: (1) double-talk detection; (2) use of emergency coefficients; (3) variable step-size; (4) far-end detection; and (5) the use of a non-linear gain function and masking, depending on the SNR.

1. Double Talk Detection

The operation of an adaptive filter 14 being used as an echo canceller 15 in its simplest form is generally for the ‘single-talk’ case. The ‘single-talk’ case can be described as the situation in which only the far-end speaker is talking, and therefore, the only input signal from the near-end side is the echo generated by the echo path. In this situation, the adaptive filter 14 can successfully correlate the far-end signal with the echo signal and cancel the echo. If, on the other hand, the near-end speaker is talking at the same time as the far-end speaker is, the adaptive filter mistakes the neat-end signal as echo. Then the adaptive filter tries to cancel the near-end signal by correlating it with the far-end signal. The result is an error signal, which will not decrease; and the adaptive filter ultimately diverges. Therefore, the fast and accurate detection of the double-talk situation and taking the necessary actions are important to the optimal operation of the echo canceller 15. The course of action that needs to be taken when double-talk is detected is to either to slow down the adaptation process or to stop it altogether. This prevents the divergence of the adaptive filter.

The above-mentioned divergence problem occurs also when only the near-end signal is present and the far-end signal is not. Therefore, double-talk detection actually becomes equivalent to the detection of the near-end signal in this context. In order to detect the presence of near-end signal, one conventional method computes the correlation of the near-end signal with the far-end signal, and if the correlation is low, double-talk is declared. One problem with this approach is that the computational complexity is high. Another method compares the near end and far-end signal levels by taking into account the estimated ERL of the echo path. The main problem with this method is that it becomes unreliable in noisy environments.

The preferred method employed in the system 10 of the present invention to detect the presence of near-end talk is by using the voice activity detector (VAD) of the speech encoder in the system. One advantage of this method is the reduction in computational complexity: In other words, by using an element of the system 10 that is already being employed for other reasons, no additional computations are needed. Another advantage is that, since the VADs of many codecs are already equipped with methods superior to most traditional double-talk detectors, their performance is more reliable, even in noisy conditions.

Although the VAD 32 is a good choice to determine the presence of near-end signal, especially after the adaptive filter has converged, and in noisy environments, it is generally insufficient until the filter adapts, or when there is very little or no noise in the environment. Until the filter adapts, there will be considerable residual echo, which can be incorrectly picked up by the VAD 32 as near-end signal. This will stop the adaptation and, as a result, the adaptive filter 14 will never have a chance to converge. Also, when the environment does not have much noise, whatever little residual echo is present after cancellation will also be classified as near-end signal. This will also cause the adaptation to stop when it should not. In a more noisy environment, low levels of residual echo can be masked within the noise and not cause this problem. Thus, in order to take care of these situations, a secondary double-talk detection mechanism 70 is employed which works on the principle of comparing near-end and far-end signal levels by taking into account the ERL estimate of the echo path, as shown in FIG. 6. This method is used during the first couple of seconds before the adaptive filter 14 has fully converged, and also when there is not much noise in the environment. The determination of the noise level in the environment is done by the SNR estimate from the noise reduction unit 16 of the system 10. When the SNR is less than a certain level, and the adaptive filter has completed the initial convergence period, the VAD 32 is used as the near-end talk detector; otherwise, the secondary double-talk detector 70 is used.

With continued reference to FIG. 6, the secondary double-talk detector preferably operates in conjunction with two components: 1) an ERL estimator 72; and 2) a near-end and far-end level comparator 74. The comparator 74 determines whether the following holds:

[s(n)+y(n)]≧ERLₑₛₜ(n)·max{x(n), . . . , x(n−N)} (6)

where s(n), y(n), and x(n) are as illustrated in FIG. 1, and ERLₑₛₜ (n) is the estimated ERL. If Equation (6) is true, then near-end presence is declared, and the adaptation is disabled. The ERL estimate is computed by the estimator 72 as follows:

ERLₑₛₜ(n)=βERLₑₛₜ(n−1)+(1−)(p_{avg}(n)/x_{avg}(n)) (7)

where x_{avg}(n) is the averaged far-end signal, and p_{avg}(n) is the averaged near-end signal p(n),

where

p(n)=s(n)+y(n). (8)

Equation (7) is carried out when the far-end signal level is sufficiently high, and when the cancellation of the echo canceller 15 is preferably at least 6 dB.

The use of the VAD 32 of the encoder 18 for near-end signal detection as described earlier, causes the decision to be delayed by one speech frame (160 samples), as indicated at 38 in FIG. 2. This is a result of the system configuration, which causes the echo cancellation to take place before the speech encoder, and as a result, the VAD decision, as can be seen in FIG. 1. This delay can be long enough for the adaptive filter 14 to start diverging and, since adaptation is stopped as soon as double-talk 76 is detected, the coefficients stay diverged for the rest of the double-talk period. In order to prevent this from happening, the emergency coefficients 80 are used in accordance with another aspect of the present invention.

2. Emergency Coefficients

The echo cancellation algorithm keeps track of the optimum set of coefficients by

emergency_coef(i,n)=β·emergency_coef(i,n)+(1−β)·current_coef(i, n) for ∀i∈{1, . . . , N} (9)

where emergency_{—coef} (i,n) is the ith emergency coefficient at time n, and current_{—coef} (i,n) is the ith element of the current adaptive filter coefficients, as indicated at 80 in FIG. 6. This computation is carried out preferably only when

ŝₘ(n)<C.ŝ_{m,min}(n) (10)

where ŝₘ(n) and ŝ_{m,min}(n) are the mean error power and minimum error power, respectively. These values are defined in the next section. C is a constant slightly larger than unity.

With continued reference to FIG. 6, whenever the adaptive filter coefficients 78 start to diverge as a result of a delayed double-talk decision 76, as mentioned above, the error starts increasing. When the error signal goes over a set threshold, the adaptation is stopped, and the current adaptive filter coefficients are replaced by the emergency coefficients 80. These emergency coefficients are used throughout the entire double-talk period. The adaptation is started again when the VAD declares single-talk.

3. Variable Step Size Algorithm

To deal with the problem of echo canceller performance degradation caused by the presence of background noise, variable step-size methods can be employed, as indicated at 82 in FIG. 6. These methods make sure that a smaller step size μ is used whenever there is significant noise present in the environment. This ensures a small steady-state error, and prevents the adaptive filter 14 from diverging in noisy conditions. At other times, a large step size is used to achieve fast adaptation. Since the use of a smaller step size in noise conditions causes the adaptation to slow down, the variable step-size algorithms can be said to establish a compromise between speed of convergence, and algorithm stability and steady-state error.

In the variable step-size method employed 82 in accordance with the present invention, the mean power of the error signal ŝ(n) is first estimated. This value is then compared with a threshold. If it is larger than the threshold, a small step-size is used with the assumption that the background noise is causing the large error. The threshold is determined by the current minimum value of the error signal. By using this method, μ becomes time-varying, and is given by:

$$μ ( n ) = \{ \begin{matrix}a , & {\hat{s}}_{m}^{2} ( n ) > A {\hat{s}}_{m \cdot min}^{2} ( n ) \\ b , & A {\hat{s}}_{m min}^{2} ( n ) > {\hat{s}}_{m}^{2} ( n ) > B {\hat{s}}_{m , min}^{2} ( n ) \\ c , & else\end{matrix} \qquad ( 11 )$$

where,

$${\hat{s}}_{m , min}^{2} ( n ) = \{ \begin{matrix}{\hat{s}}_{m}^{2} ( n ) & {\hat{s}}_{m}^{2} ( n ) < {\hat{s}}_{m , min}^{2} ( n - 1 ) \\ {\hat{s}}_{m , min}^{2} ( n - 1 ) & else\end{matrix} , \qquad ( 12 )$$

and

\hat{s}ₘ²(n)=α\hat{s}_{avg}²(n−1)+(1α)\hat{s}_{avg}²(n), (13)

with

$${s}_{avg}^{2} ( n ) = \frac{1}{{f}_{s} * 5 ms} {\sum }_{k = n - {f}_{s} * 5 ms}^{n} {{\hat{s}}^{2} ( k )}_{}^{} , \qquad ( 14 )$$

and fₛ, the sampling frequency, a, b, c, A, B are constants optimized according to the given system such that A>B, and 0≦a<b<c≦1. In addition, the far-end signal level is monitored. If it is below a certain threshold, once again, a small step size is used. This is due to the fact that, in the absence of a sufficient signal to adapt with, the use of a large step size might cause divergence of the filter.

For the use of the variable step-size algorithm of the echo canceller 15 to be effective, a method needs to be present which ensures that the error signal is due to the background noise, and not a change in the echo path or double-talk. Classical double-talk detection methods usually can not distinguish between system changes and double-talk situations. The integrated system 10 of the present invention uses the voice activity detector of the encoder 18 for double-talk detection. Since these voice activity detectors rely on a combination of techniques, they provide accurate reports of speech activity-Further, unlike most classical double talk detectors, they do not mistake system changes as double talk.

4. Far End Detection

When the far-end signal is not present, or is at a very low level, the adaptive filter does not have an input signal with which to build an echo replica. As a result, the filter cannot adapt properly, and the coefficients start to ‘drift’. This phenomenon manifests itself as uncancelled echo at the output. Therefore, in order to ensure proper operation of the echo canceller 14, the system of the present invention monitors the far-end signal level, as indicated at 84 in FIG. 6, and slows down or stops adaptation when the far-end signal level falls below a set threshold.

5. Non Linear Gain Function and Masking Noise

As explained earlier, under low SNR conditions, the noise reduction unit following the adaptive filter acts as a mild NLP, and in most cases, the use of a separate NLP is deemed unnecessary. This is partly due to the masking capability of the residual noise to hide any low-level residual echo that might remain after echo cancellation.

Under high SNR conditions, however, no masking from the residual noise is possible, and even low-level residual echoes can be audible and therefore objectionable. For these situations, the use of a non-linear gain function, which is level independent, is used to further reduce the residual echo, as indicated at 87 in FIG. 6. The use of the non-linear gain function can be represented as follows:

\hat{s}_{NLG}(n)=\hat{s}(n).NLG(n) (15)

where ŝ(n) is the output of the adaptive filter, and NLG(n) is the non-linear gain as given in:

$$NLG ( n ) = MIN ( 1.0 , \frac{{\hat{s}}_{energy} ( n )}{{( MAX ( 1.0 , ( ( {2}^{M} - 1 ) \cdot {10}^{\frac{- 32 - L}{20}} \cdot \sqrt{\frac{ltseps}{ltseps\_anl}} ) ) )}^{2}} ) . \qquad ( 16 )$$

In Equation (16),ŝ_{energy(n)} is the energy of the error signal (residual echo), M denotes the integer precision of the speech samples, and L in dB is the parameter that adjusts the suppression level. The terms ltseps and ltseps_anl correspond to ‘long term speech energy per sample’ and ‘long term speech energy per sample at nominal level’, respectively. These parameters are obtained from the VAD 32 of the encoder 18, which is preferably with reduced sensitivity to varying signal levels. The use of these parameters in the manner shown in Equation (16) ensures level independence of the non-linear gain.

In addition, it might be beneficial to use a low-level noise to mask the residual echo following the use of the non-linear gain function. In that case, the output becomes:

$${\hat{s}}_{NLG \& MN} ( n ) = {\hat{s}}_{NLG} ( n ) + ( ( {2}^{M} - 1 ) \cdot {10}^{\frac{- 32 - K}{20}} \cdot \sqrt{\frac{ltseps}{ltseps\_anl}} ) \cdot noise ( n ) . \qquad ( 17 )$$

where K is the dB level, which the noise is below nominal speech, and noise(n) is generated by a uniform number generator and takes values between 0 and 1. Similar to the non-linear gain, the masking noise is also level independent.

It is important to note that both the non-linear gain and the masking noise are effective only when the SNR is high. In low SNR conditions, the effects of these elements are negligible. This is because the values of Land K are chosen such that at low SNR the NLG is always 1.0, and the residual masking noise is insignificant compared to the noise that is already present.

The worst case complexity estimate of the echo canceller 15 on a floating-point platform is 4 MIPS. This includes the adaptation algorithm and all the control mechanisms described above, as well as the non-linear gain function and masking noise features.

The echo canceller 15 and the noise reduction unit 16 of the system 10 in FIG. 1 is preferably implemented in a C language program and tested in different noise conditions. The average MOS scores in clean and noisy conditions are given in Table 3. The scores compare the performance of the encoder 18 when there is no echo and echo canceller 15, with that of when there is the described echo canceller 15 present in the system to cancel echoes. In the noisy cases, the noise on the far-end is 12 dB street noise, and on the near-end are vehicular noise and babble noise at 15 dB each. The test files include approximately 25% double-talk.

The subjective MOS tests were conducted as per ITU-P.830 specifications. The 95% confidence limits were typically in the range of 0.1-0.15 for all of the test conditions.

TABLE 3
Test cases and results for the integrated system

| | CODEC | CODEC + EC |
|---|---|---|
| | (No Echo) | (Echo) |
| Clean | 3.8 | 3.7 |
| Speech | | |
| Vehicular Noise | 3.1 | 3.2 |
| Babble | 2.9 | 2.8 |
| Noise | | |

The subjective MOS scores indicate that the ‘no echo’ and ‘echo’ cases are statistically equivalent. This means that the echo canceller successfully cancels the existing echo, and no perceptually significant distortions are introduced to the output speech signal resulting from the use of the echo canceller.

The present invention has been implemented using a 4.0 Kbps Frequency Domain Interpolative (FDI) codec. Although the synergy described herein takes place among the echo canceller, the noise reduction unit, and the FDI codec, similar synergies can be obtained by using different codecs, echo cancellers, and noise reduction methods, as long as the set of shared computations explained in this document can be utilized in these systems as well.

The worst case complexity estimate of the echo canceller is approximately 4 MIPS. The MOS scores obtained from the subjective evaluation of the system indicate that the echo canceller successfully cancels the existing echo, and no perceptually significant distortions are introduced in the output speech signal resulting from the use of the echo canceller

Although the present invention has been described with reference to a preferred embodiment thereof, it will be understood that the invention is not limited to the details thereof. Various modifications and substitutions have been suggested in the foregoing description, and others will occur to those of ordinary skill in the art. All such substitutions are intended to be embraced within the scope of the invention as defined in the appended claims.

what is claimed is:

1. A system for providing echo cancellation in a communication system comprising:
a codec having a voice activity detector, said voice activity detector being operable to process an input signal, said input signal comprising at least one of speech and noise, said voice activity detector being operable to generate a voice activity detector (VAD) output when speech is detected in said signal; and
an echo canceller configured to receive said VAD output from said codec, said echo canceller being operable to perform double-talk detection on said input signal using said VAD output.

2. A system as claimed in claim 1, further comprising a noise reduction unit configured to receive said input signal, said noise reduction unit being operable to use the VAD output to determine where speech occurs in said input signal and facilitate processing of said input signal to reduce noise therein and generate a reduced noise input signal.

3. A system as claimed in claim 2, wherein said codec receives said reduced noise input signal

4. A system as claimed in claim 2, wherein said input signal provided to said noise reduction unit has been processed for echo cancellation by said echo canceller.

5. A system as claimed in claim 1, wherein said echo canceller is operable to perform double-talk detection using an output generated via said codec.

6. A system as claimed in claim 1, wherein said echo canceller employs an adaptive filter using an adaptation algorithm for echo cancellation.

7. A system as claimed in claim 6, wherein said adaptation algorithm implements normalized least mean square adaptation.

8. A method of providing echo cancellation in a communication system comprising the steps of:
operating an adaptive filter to reduce echo in an input signal, said input signal comprising at least one of near-end signal, echo and background noise;
detecting near-end signal; and
monitoring said signal-to-noise (SNR) of said input signal;
wherein said near-end signal is detected using a voice activity detector in a codec configured to process said input signal when said SNR is below a selected threshold and using a secondary double-talk detection process when one of a plurality of conditions occurs comprising when said SNR is above said selected threshold, and when said adaptive filter is not converged.

9. A method as claimed in claim 8, wherein a far-end signal is another input in said echo canceller and said detecting step for detecting said near-end signal using said secondary double-talk detection process comprises the steps of:
determining an echo return loss estimate; and
comparing the level of said near-end signal and said far-end signal.

10. A method as claimed in claim 9, wherein said detecting step for detecting said near-end signal using said secondary double-talk detection process further comprises the step of disabling adaptation of said adaptive filter when the level of said input signal is greater than or equal to said echo return loss estimate multiplied by the maximum of the past N samples of said far-end signal where N is the order of said adaptive filter.

11. A method of providing echo cancellation in a communication system comprising the steps of:
operating an adaptive filter to reduce echo in an input signal, said input signal comprising at least one of neat-end signal, echo and background noise;
determining the signal-to-noise ratio of said input signal; and
using a variable step-size in said adaptive filter such that step-size is reduced for low signal-to-noise ratio conditions.

12. A method as claimed in claim 11, wherein said adaptive filter is operable to generate an error signal prior to double-talk detection and to adjust coefficients corresponding to said adaptive filter and further comprising the steps of performing double-talk detection using the voice activity detector in the codec at the near-end of said communication system.

13. A method as claimed in claim 11, wherein said adaptive filter generates an error signal characterized by the reduced echo and to adjust coefficients of the said adaptive filter, the sampling further comprising the steps of:
estimating the mean power of said error signal;
determining a threshold corresponding to the current minimum value of said error signal;
comparing said mean power with said threshold; and
employing small step-size for said sampling step when said mean power exceeds said threshold.

14. A method of providing echo cancellation in a communication system comprising the steps of:
operating an adaptive filter to reduce echo in an input signal, said input signal comprising at least one of near-end signal, echo and background noise, said adaptive filter being operable to generate an error signal prior to detection of double-talk and to adjust coefficients corresponding to said adaptive filter;
dynamically updating said coefficients;
generating emergency coefficients when mean error power is determined to be less than a selected threshold; and
ceasing adaptation of said coefficients and substituting said emergency coefficients with current said coefficients when said error signal exceeds said selected threshold.

15. A method of providing echo cancellation in a communication system comprising the steps of:
operating an adaptive filter to reduce echo in an input signal, said input signal comprising at least one of near-end signal, background noise and echo;
detecting near-end signal; and
monitoring said signal-to-noise ratio (SNR) of said input signal;
dynamically operating said adaptive filter depending on said SNR, a primary double-talk detection process being used when said SNR is above a selected threshold and a secondary double-talk detection process being used when one of a plurality of conditions occurs comprising when said SNR being below said selected threshold, and when said adaptive filter is not converged.

16. A method as claimed in claim 15, wherein a non-linear gain function on the output of said adaptive filter is effective when said SNR is high.

17. A method as claimed in claim 16, further comprising the step of using a low-level noise to mask said echo after said non-linear gain function.

18. A system for providing echo cancellation and noise reduction comprising:
an echo canceller configured to receive an input signal comprising at least one of near-end signal, echo and background noise and employing adaptive filtering;
a noise reduction unit connected to said echo canceller; and
an encoder connected to said noise reduction unit and comprising a voice activity detector, said voice activity detector being operable to determine when frames in said input signal comprise speech, said encoder being operable to generate a signal-to-noise ratio estimate;
wherein said system operates in a selected one of a first mode and a second mode depending on said signal-to-noise ratio estimate, said first mode employing at least one of a variable step-size process, primary double-talk detection based on said voice activity detector and emergency coefficients with respect to said adaptive filtering when said signal-to-noise ratio estimate is below a selected threshold, said second mode employing at least one of secondary double-talk detection, far-end monitoring, a non-linear gain function and masking noise when said signal-to-noise ratio estimate is above a selected threshold.

19. A system as claimed in claim 18, wherein said adaptive filtering is implemented via a normalized least mean square algorithm.

20. A system as claimed m claim 18, wherein said noise reduction unit further decreases residual echo when said signal-to-noise ratio estimate is below a selected threshold.

21. A system as claimed in claim 18, wherein said secondary double-talk detection employs an echo return loss estimator and a comparator for said near-end signal and a far-end signal.

22. A system as claimed in claim 18, wherein said adaptive filtering employs adaptive filter coefficients, said emergency coefficients replacing said adaptive filter coefficients when said adaptive filter coefficients start to diverge as in a period of double-talk.

23. A system as claimed in claim 18, wherein said variable-step size process is used with respect to said echo canceller to selectively change the rate of adaptation via said adaptive filtering depending on said signal-to-noise ratio estimate.

24. A system as claimed in claim 18, wherein the rate of adaptation via said adaptive filtering is selectively changed depending on the level of far-end signal detected via said far-end monitoring.
